(19) United States
(12) Patent Application Publication
(10) Pub. No.: US 2012/0128818 A1
(43) Pub. Date: May 24, 2012

(54) POLYMER COMPOSITIONS BASED ON POLYVINYL ALCOHOL FOR CHEWING GUM FORMULATIONS WITH A LOW ADHESIVE IMPACT

(76) Inventors: Salvatore Paffumi, Milano (IT); Ivan Fuso Nerini, Milano (IT)

(21) Appl. No.: 13/380,530

(22) PCT Filed: Jun. 22, 2010
(86) PCT No.: PCT/EP10/03750

§ 371 Date: Feb. 1, 2012

(30) Foreign Application Priority Data
Jun. 25, 2009 (IT) MI2009A001127

(51) Int. Cl. A23G 4/08

(52) U.S. Cl. 426/4

(57) ABSTRACT

Disclosed are polymers derived from vinyl acetate, vinyl alcohol and other monomers with elastic and plastic characteristics, which are useful to prepare gum base for chewing gum with a low environmental impact and reduced adherence.

The present invention relates to polymer materials which considerably reduce the tack of chewing gum, thus allowing chewing gum litter to be removed from surfaces with inexpensive conventional techniques.

### BACKGROUND OF THE INVENTION

The ingredients of chewing gum are not environment-friendly.

During and after chewing, chewing gum retains considerable adherence which, in the event of improper use after chewing, causes a strong bond to form with the surfaces with which it comes into contact, especially flooring, walls, asphalt, furniture, monuments, shoes or other clothes, fabrics and the like.

As known to those working in the industry, many local councils have begun to examine the possibility of charging chewing gum manufacturers, by imposing a tax on the product, for the costs of cleaning roads and pavements following environmental damage caused by littering.

The removal of chewing gum is not only operationally very difficult but also extremely expensive, and implementing such a system could lead to heavy fines for littering with a consequent reduction in consumption or even, as used to be the case in Singapore, prohibition of chewing gum consumption.

It is well known that the adherence of chewing gum to various substrates is basically caused by the binders and resins contained in the gum base.

The problem is not easy to solve, because any modification tending to make the material less tacky is liable to alter its characteristics, especially in terms of flavour and chewability.

The problem is further aggravated by the fact that the polymer systems used in the gum base are chemically very different, which means that a solution that works for some types of polymer is not necessarily applicable to others.

The polymers currently allowed by national and international legislation are substantially as follows:

1. Styrene-butadiene

2. Butyl rubber

3. Polyisobutylene

4. Polyisoprene

5. Polyvinyl acetate (PVAC)

6. Vinyl acetate/vinyl laurate copolymer

These polymers must meet a series of purity and non-toxicity requirements.

In addition to said polymers, additional substances are also allowed, such as terpene resins, hydrogenated and non-hydrogenated rosin resin esters, various emulsifiers and other technological auxiliaries.

Each of these components is part of the gum base and has a specific function, as indicated below.
1. Styrene-butadiene, butyl rubber, polyisobutylene and polyisoprene are elastomers which influence the chew characteristics of the product, especially its elasticity.
2. Vinyl acetate/vinyl laurate copolymer and PVAC also influence the chew characteristics in terms of the plasticity of the product, although they do not possess the elastic characteristics of said elastomers. Due to their characteristics, these polymers are identified by the American FDA as “masticatory substances”.
3. Terpene resins, and rosin resins which may optionally be esterified or hydrogenated, have the function of plasticising the elastomers, thus modifying their chew characteristics. The American FDA classifies them as Plasticizing Materials (Softeners).

Other ingredients can also be added to the gum base to modify and/or improve the characteristics given to it by the above-mentioned ingredients, such as monoglycerides, lecithins, hydrogenated vegetable oils, waxes, mineral fillers, etc.

The combination of these constituents gives the gum base and the chewing gum deriving from it the desired optimum properties of chewability and flavour.

In practice, one of the main characteristics of chewing gum, apart from its appreciable organoleptic characteristics, is good elastoplastic chewability which does not tire the face muscles, and lack of adherence to the components of the oral cavity.

The elastoplastic characteristics are normally supplied by elastomeric polymers; however, they generally present the contraindication of high adherence, which must be offset by formulating the gum base with detaching agents such as waxes and the like. This combination of ingredients presents the serious drawback of not being at all hydrophilic, which means that it is extremely complicated to remove the product, once chewed, from surfaces (e.g. roads, pavements, etc.), even with strong jets of water.

The patent literature describes various solutions for obtaining a chewing gum which, once chewed and improperly thrown away (e.g. on the ground), is easily removable.

The proposed solutions are generally based on the inclusion in the formulation of a biodegradable component which causes a sufficiently rapid breakdown of the chewing gum.

Another solution involves changing the elastomeric characteristics that make the product tacky when dry, by adding a hydrophilic part to the polymer matrix, either as an additional component or at the synthesis stage, so that the product, while retaining the preceding characteristics, loses its tack in the presence of polar liquids (e.g. water, saliva etc.) without becoming soluble therein. The resulting gum could be easily removed by washing.

WO 2006/016179 discloses the reduced adherence of synthetic and natural polymers achieved by inserting hydrophilic side chains in the polymer chain. The structure of the lipophilic polymer is linear, and based on the most common formulations used for the gum base (polyisoprene, polybutadiene, polyisobutylene and copolymers thereof, including butadiene styrene copolymer). Long hydrophilic branches, mainly consisting of polyethylene glycol, are inserted into this polymer structure, which is suitably “grafted” with maleic anhydride.

US2008/0107770 discloses the addition of a biodegradable homopolymer based on lactic acid to the elastomeric component of the gum base.

US2007/0042079 discloses the insertion in the chewing gum formulation, together with the elastomeric component, of substances containing a non-stick component with lipophilic functions oriented towards the inside of the mass, and outwardly-oriented hydrophilic functions. This category includes a series of natural fats and oils, fatty acids and esters thereof. This arrangement would make it easier to detach the structures from the oral cavity.

Said patent also discloses the presence of photosensitive biodegradable substances, such as chlorophyll, which would cause the chewing gum to fragment in 10 weeks.

US2008/233233 discloses a polymer composition which, in addition to the elastomeric portion, contains a methyl vinyl ether/maleic anhydride/maleic acid terpolymer hydrolysed by atmospheric agents. A method of manufacturing a chewing gum with accentuated degradation characteristics, obtained by mixing a gum base with a hydrolophilic acid polymer (containing malic anhydride), is also disclosed. The use of photosensitive components (chlorophyll) is also disclosed.

FR 1 505 267 discloses the use of ethylene-vinyl acetate copolymers to prepare the gum base. The hydrolysis of the acetate groups is not described; said hydrolysis does not take place spontaneously, but requires basic or strong acid conditions.

However, none of said proposed solutions has actually been implemented to date.

The saponification kinetics of vinyl acetate copolymers with various co-monomers are also known (Angewandte Makromol. Chemie, (4/5), 310-51, 1968). However, no practical application of said copolymers has been described.

### DESCRIPTION OF THE INVENTION

It has now been found that the problems of the prior art can be overcome by using polymers containing specific functionalities which give the chewing gum formulation a low adhesive impact in the presence of aqueous liquids.

The polymers with low adhesive impact usable according to the invention are derived from monomers selected for their specific characteristics of plasticity, elasticity and hydrophilia, to rationalise the formulation of the chewing gum and make it easily removable from surfaces.

The polymers which can be used according to the invention substantially have a vinyl acetate base and contain a lipophilic elastomer part and a hydrophilic part: it is the right combination of these two characteristics that enables the technical problems discussed above to be advantageously solved.

The elastomeric part can wholly or partly replace the known elastomeric systems, while the hydrophilic part gives the formulation characteristics of lower adherence, making it easily removable simply by washing with water.

A further advantage of the invention is that it tends to simplify the formulations of the gum base, because the elastomeric part, the hydrophilic part and the plasticity modifier coexist in the same polymer in proportions which can be varied, according to the desired characteristics.

The first aspect of the invention relates to the use of polymers containing vinyl alcohol to reduce the environmental impact and adhesive properties of gum base compositions.

In particular, the vinyl alcohol component in the polymers derives from partial hydrolysis of a “parent” polymer comprising polyvinyl acetate.

The parent polymer is a polyvinyl acetate polymer or a copolymer of polyvinyl acetate and an elastic polymer characterised by a Tg higher or lower than that of polyvinyl acetate.

The polymer containing vinyl alcohol is a terpolymer obtainable by hydrolysis of parent copolymers of polyvinyl acetate and an elastic polymer characterised by a Tg lower than that of polyvinyl acetate.

The invention also relates to polymers consisting of vinyl acetate and vinyl alcohol, and preferably also other monomers, in such a ratio as to obtain a glass transition temperature which gives elastoplastic characteristics suitable for better application in the final formulation. The invention also relates to a process for the preparation of gum base compositions which comprises copolymerisation of vinyl acetate with one or more monomers able to provide an elastic copolymer component with a low glass transition temperature and optionally also a plastic component having a Tg higher than polyvinyl acetate, followed by partial hydrolysis of the acetate groups to give the vinyl alcohol component.

The invention also relates to the polymers obtainable by said process and gum base compositions containing said polymers for the preparation of easily removable chewing gums with a low adhesive impact.

### DETAILED DESCRIPTION OF THE INVENTION

The elastic component included in the composition of the polymers to which the invention relates is preferably a polymer of vinyl propionate, ethylene, versatic acid vinyl esters or aliphatic acid vinyl esters with a molecular weight higher than that of vinyl propionate. Polymers and copolymers of vinyl esters of propionic acid or versatic acid, in particular versatic acids C9-C12, are particularly suitable. Aliphatic acid vinyl esters having up to 18 carbon atoms are equally suitable.

Versatic acid vinyl esters C9 and C10 are commercially available, for example, under the brands VeoVa 9® and VeoVa 100 made by Hexion.

The polymers according to the invention typically have a molecular weight of between 10,000 and 100,000, preferably between 15,000 and 70,000.

The percentages by weight of polyvinyl acetate in the polymers can be between 20 and 90%, while those of polyvinyl alcohol can range between 10 and 60%, and preferably between 20 and 50%.

The percentages by weight of the elastic polymer can range between 0 and 50%.

The polymerisation can be performed in solution, or preferably in the mass, in the presence of an initiator soluble in the monomers, in particular a peroxide initiator, and optionally a chain transfer agent, preferably isopropyl alcohol. Mass polymerisation of polyvinyl acetate produces a finished product of high purity (practically devoid of unreacted monomer).

The monomers are introduced into the reactor, the initiator soluble in the monomer is added, and the polymerisation reaction is commenced. The mass of the system starts to become highly viscous, and the molecular weights can be regulated with suitable transfer agents, no detectable trace of which remains after the purification process.

The purification process requires a long period at high temperature and continuous washing with water or steam to remove the water-soluble and insoluble substances by distillation under vacuum in a steam current.

The acetate groups are preferably hydrolysed in methanol in the presence of acids or bases, preferably strong inorganic acids in methanol solution: part of the plastic component of vinyl acetate (VAC) is thus converted to vinyl alcohol (VAL), which constitutes the hydrophilic component of the terpolymer.

The hydrolysis reaction can be conducted at room temperature or at the boiling point of the medium, and can be stopped at any desired molar percentage value. As it does not exist as a monomer, the production of VAL by this procedure also presents the advantage of obtaining an end product containing no impurities of any kind.

The polymer thus obtained is not soluble during chewing, and does not modify the organoleptic characteristics of the end product.

The presence of the hydrophilic function in the polymer in question means that, in the presence of water at room temperature and without any kind of stirring, the product is completely plasticised in 1-2 days. Otherwise, the corresponding types of homopolymer consisting of VAC as plastic component and copolymers consisting of VAC and monomers with elastic characteristics do not begin to plasticise under comparable experimental conditions, even after 2-3 weeks.

The following examples illustrate the invention in greater detail.

The following examples and preparations illustrate the procedure and the characteristics of the different types of parent polymers, and the products obtainable by the subsequent hydrolysis operation, the use of which forms the subject of the invention.

Preparation 1: Preparation of a Parent Homopolymer for Gum Base Consisting of Pure PVAC.

The preparation is performed in a pilot reactor fitted with: stirrer, condenser, temperature gauges, feed systems. The reactor is fitted with a heat-regulation jacket for heating, cooling and thermostating purposes.

The following amounts of raw materials are used as initial load, with reference to the conventional 100 parts of monomer (phm):
AVM: 50
isopropyl alcohol: 10
t-butyl peroxydiethylacetate: 0.20

The solution is heated to the temperature of approx. 70° C.

The increase in reflux amount constitutes the reaction starting time. The introduction of a solution similar to the one indicated begins after 1 hour. The feed time, at a constant flow rate, is 4 hours.

By regulating the jacket, the operation is performed at a practically constant reflux.

The operations involving elimination of the organic phase and purification of the product of reaction begin after the established exhaustion period. Said operations are performed on the basis of the following successive distillation stages: at room pressure, under vacuum, in a steam current, under terminal vacuum.

The type of PVAC obtained presents the following characteristics:

value K=20 Mw=17000, Tg=27° C.,

residual monomer <5 ppm.

For the behaviour tests, approx. 10 g stripes of the type of PVAC obtained are immersed in glass containers full of water.

After a period of 1-2 weeks at room temperature, the polymer still retains its initial transparency.

The PVAC is also attached to the base of the container.

### Example 1

### Introduction of the Hydrophilic Function into the Parent Homopolymer

This particular type of product is obtained by acid methanolysis reaction of the PVAC previously obtained.

In practice, at the end of the purification operation, the product in question is solubilised in methanol at the concentration of 45%.

The system is then heated to the boiling point of the solvent. The methanolysis process begins with the addition of sulphuric acid. In this reaction, methyl acetate (MeAc) is formed and methanol (MeOH) is consumed in amounts equimolecular to the degree of hydrolysis reached by the PVAC.

The boiling point of the MeAc/MeOH system declines in proportion to the molar increase in MeAc.

When the boiling point corresponding to the established degree of hydrolysis has been reached, the reaction is stopped by adding sodium hydrate.

The organic phase is then extracted and the product purified on the basis of the procedures already described.

For the type of product in question, the degree of hydrolysis of the PVAC present was set at a molar value of 33%.

The polymer obtained therefore consists of:

composition by weight: AVM=80%, vinyl alcohol=20%

molar composition: AVM=67%, vinyl alcohol=33%

The copolymer is also characterised by:

value K=21 Mw=17000 Mw/Mn=1.9 Tg=40° C. residual monomers=<5 ppm.

For the behaviour tests, approx. 10 g stripes of the type of PVAC obtained are immersed in glass containers full of water.

After 1-2 days at room temperature, the product is completely plasticised, and easily removed from the base of the container.

Preparation 2: Preparation of a Parent Copolymer

for gum base consisting of VAC and vinyl propionate

The preparation takes place in the same type of reactor as previously described. Again with reference to conventional phm values, the following amounts of raw materials are used as initial load:
AVM: 43
vinyl propionate: 7
isopropyl alcohol: 10
t-butyl peroxydiethylacetate: 0.20

The polymerisation reaction and the operations involving elimination of the organic phase and purification of the product are conducted according to the procedure previously described.

The copolymer has the following general characteristics:

value K=20, Mw=17000, Tg=20° C.

residual monomers=<5 ppm.

composition by weight: AVM=86%, vinyl propionate=14%.

molar composition: AVM=88%, vinyl propionate=12%.

For the behaviour tests, approx. 10 g stripes of the type of copolymer obtained are immersed in glass containers full of water.

After a period of 1-2 weeks at room temperature, the polymer still retains its initial transparency.

The copolymer is also attached to the base of the container.

### Example 2

### Introduction of the Hydrophilic Function into the Parent Copolymer

As already stated, this particular type of terpolymer is obtained by acid methanolysis reaction of the parent previously prepared.

In practice, at the end of the purification operation, the product in question is solubilised in methanol at the concentration of 50% and then heated to boiling point.

The reaction in question is conducted according to the procedure already described in example 1.

The degree of hydrolysis of the VAC present was set at a molar value of 35%. The terpolymer is therefore characterised by:

composition by weight:
AVM=66%, vinyl propionate=16%, vinyl alcohol=18%
molar composition: AVM=57%, vinyl propionate=12%, vinyl alcohol=31%.

The terpolymer is also characterised by:

value K=22, Mw=20000, Tg=24° C.

residual monomers=<5 ppm.

For the behaviour tests, approx. 10 g stripes of the type of polymer obtained are immersed in glass containers full of water.

After 1-2 days at room temperature, the product is completely plasticised, and easily removed from the base of the container.

Preparation 3: Preparation of a Parent Terpolymer for Gum Base Consisting of VAC, Vinyl Propionate and VeoVa 9

The preparation takes place in the same type of reactor as previously described.

Again with reference to conventional phm values, the following amounts of raw materials are used as initial load:
AVM: 36
vinyl propionate: 7
VeoVa 9: 7
isopropyl alcohol: 10
t-butyl peroxydiethylacetate: 0.25

The polymerisation reaction and the operations involving elimination of the organic phase and purification of the product are conducted according to the procedure previously described.

The terpolymer obtained has the following approximate general characteristics:
composition by weight: AVM=72%, vinyl propionate=14%, VeoVa 9=14%.
molar composition: AVM=79.5%, vinyl propionate=13.3% VeoVa 9=7.2%.

value K=23, Mw=24000, Tg=25° C.

residual monomers=<10 ppm.

For the behaviour tests, approx. 10 g stripes of the type of copolymer obtained are immersed in glass containers full of water.

After a period of 1-2 weeks at room temperature, the polymer still retains its initial transparency.

The terpolymer is also attached to the base of the container.

### Example 3

### Introduction of the Hydrophilic Function into the Parent Terpolymer

As already stated, this particular type of polymer is obtained by acid methanolysis reaction of the parent previously prepared.

In practice, at the end of the purification operation, the product in question is solubilised in methanol at the concentration of 50% and then heated to boiling point.

The reaction in question is conducted according to the procedure already described in example 1.

The degree of hydrolysis of the PVAC present was set at a molar value of 38%. The polymer is therefore characterised by:
composition by weight: AVM=52%, vinyl propionate=16% Veova 9=16%, vinyl alcohol=16%.
molar composition: AVM=49%, vinyl propionate=14% Veova 9=7%, vinyl alcohol=30%.

The polymer is also characterised by:

value K=25, Mw=30000, Tg=30° C.

residual monomers=<10 ppm.

For the behaviour tests, approx. 10 g stripes of the type of polymer obtained are immersed in glass containers full of water.

After 1-2 days at room temperature, the product is completely plasticised, and easily removed from the base of the container.

Preparation 4: Preparation of a Copolymer for Gum Base Consisting of PVAC and an Elastic Component.

The preparation takes place in the same type of reactor as previously described.

Again with reference to the conventional 100 parts of monomer (phm), the following amounts of raw materials are used as initial load:
AVM: 35
VeoVa 10: 15
isopropyl alcohol: 10
t-butyl peroxydiethylacetate: 0.20

The polymerisation reaction and the operations involving elimination of the organic phase and purification of the product are conducted according to the procedure previously described.

The copolymer has the following general characteristics:

value K=21, Mw=18000, Tg=20° C.

residual monomers=<10 ppm.

Composition by weight: AVM=70%, VeoVa 10=30%.

Molar composition: AVM=84%, VeoVa 10=16%.

For the behaviour tests, approx. 2 g stripes of the type of copolymer obtained are immersed in glass vessels containing water.

After a period of 3-4 weeks at room temperature, the copolymer still retains its initial transparency. The product is also attached to the base of the container.

### Example 4

### Preparation of a Terpolymer for Gum Base Consisting of VAC, an Elastic Component and a Polymer Characterised by Hydrophilic Functions

This particular type of product is obtained by acid methanolysis reaction of the copolymer obtained in preparation 5.

In practice, at the end of the purification operation, the product in question is solubilised in methanol at the concentration of 50%. The system is then heated to the boiling point of the solvent.

The methanolysis process begins with the addition of sulphuric acid.

In this reaction, methyl acetate (MeAc) is formed and methanol (MeOH) is consumed in amounts equimolecular to the degree of hydrolysis reached by the VAC.

The boiling point of the MeAc/MeOH system declines in proportion to the molar increase in MeAc.

When the boiling point corresponding to the established degree of hydrolysis has been reached, the reaction is stopped by adding sodium hydroxide.

The organic phase is then extracted and the product purified on the basis of the procedures already described.

For the type of product in question, the degree of hydrolysis of the PVAC present was set at a molar value of 50%. The polymer obtained therefore consists of:
Molar composition: AVM=42%, VeoVa 10=16%, vinyl alcohol=42%
Composition by weight: AVM=42%, VeoVa 10=36%, vinyl alcohol=22%

The terpolymer is also characterised by:

value K=21, Mw=18000, Tg=24° C., monomer

residues=<10 ppm.

For the behaviour tests, approx. 2 g stripes of the terpolymer obtained are immersed in glass vessels containing water.

After 1-2 days at room temperature, the product is completely plasticised, and easily removed from the base of the container.

### Example 5

### Comparison of Elasticity

The polymer obtained in Preparation 1 and the polymer obtained in Example 5 are crushed into approx. 1 cm pieces, laid on polyester film, placed in a ventilated stove for 1 h at 100° C. to melt, and cooled in a dryer for 1 h. Bars of the following dimensions are cut from the slab thus produced:

Width=11±1 mm Length=30±1 mm Thickness=2.0±0.1 mm.

The specimens are fixed to the clamps of the instrument and immediately immersed in water for the test. The instrument is a dynamic mechanical analyser (DMA) made by Netzsch, model 242 C.

The variation in rigidity of the samples, identified as “ΔE′”, is evaluated as the reduction in the modulus of elasticity after immersion in water for 2 h at 23°±1° C.; it is associated with water absorption “Ap” (namely variation in weight after immersion in water for 2 h at 23°±1° C.). The results are set out in the table below:

| | Variation after 2 h in water | |
|---|---|---|
| | ΔE′ (%) | Δp (%) |
| Preparation 1 | 17 ± 1 | 1.0 ± 0.1 |
| Example 4 | 48 ± 3 | 3.5 ± 0.2 |

On the basis of the tests performed, it can be deduced that the sample described in example 4 loses nearly 50% of its rigidity after 2 h in water, and at the same time absorbs nearly 4% of water, compared with the product described in Preparation 1, which loses under 20% of its modulus of elasticity with only 1% of water absorption.

1. A gum base composition comprising a terpolymer of polyvinylacetate, vinyl alcohol and an elastic polymer characterised by a Tg lower than that of polyvinyl acetate to reduce the environmental impact and adhesive and elastic properties of gum base compositions.

2. The composition as claimed in claim 1, wherein the vinyl alcohol derives from partial hydrolysis of a parent polymer containing polyvinyl acetate.

3. (canceled)

4. The composition as claimed in claim wherein the terpolymer is obtainable by hydrolysis of copolymers of polyvinyl acetate and an elastic polymer characterised by a Tg lower than that of polyvinyl acetate.

5. (canceled)

6. The composition as claimed in claim 1, wherein the elastic polymer is a polymer of vinyl propionate, ethylene, versatic acid vinyl esters, vinyl esters up to 18 carbon atoms, or vinyl pivalate.

7. The composition as claimed in claim 6, wherein the elastic polymer is a polymer of vinyl propionate or versatic acid vinyl esters.

8. The composition as claimed in claim 7, wherein the versatic acid vinyl ester is an ester of a C9-C12 versatic acid.

9. The composition as claimed in claim 1, wherein the polymer has a molecular weight of between 10,000 and 100,000, preferably between 15,000 and 70,000.

10. The composition as claimed in claim 1, wherein polyvinyl acetate is present in percentages by weight of between 20 and 90%, vinyl alcohol in percentages by weight of between 10 and 60%, preferably between 20 and 50%, and the elastic or plastic polymer in percentages by weight of between 10 and 50%.

11. A process for the preparation of gum base compositions involving copolymerisation of vinyl acetate with one or more monomers able to provide an elastic copolymer component with a low glass transition temperature and optionally a plastic component having a Tg higher than that of polyvinyl acetate, followed by partial hydrolysis of the acetate groups to give the vinyl alcohol component.

12. The process as claimed in claim 11, wherein the monomer which is copolymerised with the vinyl acetate is vinyl propionate, ethylene, vinyl pivalate, versatic acid vinyl esters or vinyl esters with a molecular weight higher than that of vinyl propionate.

13. The process as claimed in claim 11, wherein the copolymerisation is performed in mass in the presence of an initiator soluble in the monomers, in particular a peroxide initiator, and optionally in the presence of a chain transfer agent, preferably isopropyl alcohol.

14. The process as claimed in claim 11, wherein the acetate groups are hydrolysed in methanol in the presence of strong inorganic acids.

15. Easily removable chewing gum with a low adhesive impact obtainable by the process disclosed in claim 11.
